(19) United States
(12) Patent Application Publication
(10) Pub. No.: US 2006/0222429 A1
(43) Pub. Date: Oct. 5, 2006

(54) Printing/processing system, printing device, processing device, printing/processing apparatus, method for controlling printing/processing system, program, and storage medium

(75) Inventor: Hiroyasu Kurashina, Matsumoto-shi (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 11/371,499

(22) Filed: Mar. 8, 2006

(30) Foreign Application Priority Data
Mar. 29, 2005 (JP) 2005-095562

(51) Int. Cl. B41J 29/38; B41J 11/66; B41J 3/32

(52) U.S. Cl. 400/76; 400/621; 400/109.1

(57) ABSTRACT

A printing/processing system includes a printing mechanism performing a printing operation on a processing sheet; a processing mechanism performing a processing operation on the printed processing sheet; and a memory device into which the printing mechanism writes information and from which the processing mechanism reads information. The printing mechanism includes an input unit for inputting printing information for performing the printing operation and processing information for allowing the processing mechanism to execute the processing operation; an information-writing unit that writes process data into the memory device in correspondence with process-specifying data provided for specifying the process data, the process data being a control program and/or control data based on the input processing information; and a printing unit that prints print data and the process-specifying data on the processing sheet, the print data corresponding to the input printing information. The processing mechanism includes a reading unit that reads the process-specifying data printed on the processing sheet; an information-readout unit that refers to the memory device and reads out the process data corresponding to the read process-specifying data from the memory device; and a processing unit that performs the processing operation based on the read process data.

The entire disclosure of Japanese Patent Application No. 2005-095562, filed Mar. 29, 2005, is expressly incorporated by reference herein.

### BACKGROUND

1. Technical Field

The present invention relates to The present invention relates to a printing/processing system that includes a printing mechanism performing a printing operation on a processing sheet, a processing mechanism performing a processing operation on the printed processing sheet, and a memory device into which the printing mechanism writes information and from which the processing mechanism reads information. Furthermore, the invention also relates to a printing device, a processing device, and a printing/processing apparatus, which are applied to the printing/processing system. Furthermore, the invention also relates to a method for controlling the printing/processing system. Furthermore, the invention also relates to a program and a storage medium.

2. Related Art

There is known an apparatus for making braille labels and braille receipts that are recognizable by both visually-impaired persons and sighted persons. Specifically, in this apparatus, a string of braille characters recognizable by visually impaired persons and a string of ink characters (i.e. common printed characters with respect to braille characters) visually recognizable by sighted persons are printed on the same medium. JP A-2003-182158 is an example of related art (see FIG. 5, or the like).

In such an apparatus, printing information for printing ink characters and embossing information for embossing braille characters are preliminarily input and edited, and an ink-character printing operation and a braille-embossing operation are performed consecutively based on the corresponding information. For this reason, the apparatus is not suitable for use in a case where the label-making operation is temporarily discontinued (by shutting off the power) after the end of the ink-character printing operation since the braille-embossing operation in this case cannot be performed at a later time. Moreover, the apparatus is also not suitable for use in a case where a plurality of braille labels having different contents is to be made by first performing an ink-character operation on a bundle of labels and subsequently performing an embossing operation on the bundle of printed labels.

In order to enable the apparatus to correspond to the above cases, the apparatus may be subject to a design change such that the printing information is solely input first to produce ink-character labels, and the embossing information is input subsequently to perform the braille-embossing operation on the preliminarily produced ink-character labels. However, this is problematic in that if the printing information and the embossing information are input and edited individually for the corresponding operations, it is difficult to expect the final result of each braille label. On the other hand, it is possible to allow the apparatus to perform the ink-character printing operation and the braille-embossing operation based on the same information if the content of the ink-character print data and the content of the braille emboss data are the same. However, since the printing operation and the processing operation are performed independent of each other in the above-mentioned apparatus, the same information must be input individually for each operation, which is time-consuming.

### SUMMARY

An advantage of the invention is that it provides a printing/processing system, a printing device, a processing device, a printing/processing apparatus, a method for controlling the printing/processing system, a program, and a storage medium in which printing information for performing a printing operation and processing information for executing a processing operation, such as a braille-embossing operation, are preliminarily input and edited, and in which the printing operation and the processing operation are performed independently based on the corresponding information.

According to an aspect of the invention, a printing/processing system includes a printing mechanism performing a printing operation on a processing sheet; a processing mechanism performing a processing operation on the printed processing sheet; and a memory device into which the printing mechanism writes information and from which the processing mechanism reads information. The printing mechanism includes an input unit for inputting printing information for performing the printing operation and processing information for allowing the processing mechanism to execute the processing operation; an information-writing unit that writes process data into the memory device in correspondence with process-specifying data provided for specifying the process data, the process data being a control program and/or control data based on the input processing information; and a printing unit that prints print data and the process-specifying data on the processing sheet, the print data corresponding to the input printing information. The processing mechanism includes a reading unit that reads the process-specifying data printed on the processing sheet; an information-readout unit that refers to the memory device and reads out the process data corresponding to the read process-specifying data from the memory device; and a processing unit that performs the processing operation based on the read process data.

According to another aspect of the invention, a method for controlling a printing/processing system that performs a printing operation on a processing sheet and a processing operation on the processing sheet is provided. The method includes obtaining printing information for performing the printing operation and processing information for performing the processing operation; writing process data into a memory device in correspondence with process-specifying data provided for specifying the process data, the process data being a control program and/or control data based on the obtained processing information; printing print data and the process-specifying data on the processing sheet, the print data corresponding to the obtained printing information; reading the process-specifying data printed on the processing sheet; reading out the process data corresponding to the read process-specifying data by referring to the memory device; and performing the processing operation based on the read process data.

Accordingly, the printing mechanism prints the print data based on the input printing information together with the process-specifying data for specifying the process data on the same processing sheet, and also writes the process data based on the input processing information into the memory device in correspondence with the process-specifying data. Thus, the processing mechanism reads the printed process-specifying data and executes the processing operation by referring to the memory device. In other words, the printing information and the processing information are preliminarily input and edited, and the operations based on the corresponding information are performed independently by the printing mechanism and the processing mechanism. In this case, the term “independently” does not include the meaning of serial processing in which the printing operation and the processing operation are performed in a serial fashion nor the meaning of parallel processing in which the printing operation and the processing operation are performed in a parallel fashion.

Furthermore, since the processing mechanism reads the printed process-specifying data and executes the processing operation by referring to the memory device, the printing operation and the processing operation are reliably and properly performed based on the simultaneously-input printing information and processing information. In other words, this prevents a mismatch between the content of the printing operation and the content of the processing operation, whereby an end product desired by a user can be attained.

Furthermore, since only the information for specifying the content of the processing operation needs to be printed as the process-specifying data, the process data itself (i.e. the control information for performing the processing operation) does not need to be included in the process-specifying data. Accordingly, a specification number (numerical value) indicating control data, for example, may be printed as the process-specifying data, which implies that the data can be simplified. Moreover, this also simplifies the structure of the reading unit and thus prevents false operation caused by a misreading of the code by the reading unit.

Furthermore, since the process data generated based on the processing information is written into the memory device beforehand and the processing mechanism reads out the process data from the memory device in order to perform the processing operation, an implementation of a processing operation that requires a large data volume is possible.

Moreover, since the two operations are performed independently, the complex and large-size structure seen in general apparatuses that perform the two operations in a serial fashion or a parallel fashion is prevented. In this case, instead of inputting the printing information and the processing information individually, a single piece of information that is common between the printing information and the processing information may be input.

In the above-referenced printing/processing system, the process-specifying data is preferably an optically readable code.

Accordingly, the process-specifying data may be, for example, a two-dimensional code, a bar code, or a code string including a plurality of symbols or characters. The two-dimensional code may be, for example, a QR code, a Maxi code, a Veri code, a data matrix, or PDF417.

Furthermore, the processing sheet preferably includes an information formation layer on which the printing operation is performed, and a release layer attached to a rear surface of the information formation layer. The printing mechanism may further include a half-cutting unit that half-cuts the processing sheet in a width direction thereof in a manner such that the information formation layer is cut along a position proximate a leading end or a trailing end of the processing sheet with respect to a conveying direction of the processing sheet, the information formation layer thus being given a non-printing region in which the print data is not printed. Moreover, the printing unit preferably prints the process-specifying data in the non-printing region.

Accordingly, since the process-specifying data is printed in the non-printing region defined by half-cutting, the visibility of a region in which the print data is printed, for example, is prevented from being impaired, thereby preventing the end product from being adversely affected. Moreover, the half-cutting treatment allows the release sheet to be peeled off readily from the base sheet.

Furthermore, the processing operation performed on the processing sheet by the processing unit preferably includes a braille-embossing operation and/or a text cutout operation.

Accordingly, the aspects of the invention are applicable to a case where the processing sheet is subject to the printing operation (ink-character printing operation), the braille-embossing operation, and/or the text cutout operation. In this case, the text cutout operation includes a full-cutting treatment and a half-cutting treatment of the processing sheet in addition to the formation of cutout text (including symbols and figures).

Furthermore, the memory device is preferably included in a personal computer. In this case, the printing mechanism and the processing mechanism are preferably independent of each other, and may each include a communication unit that communicates with the personal computer.

Accordingly, the printing/processing system is used by connecting the printing mechanism and the processing mechanism to the personal computer. Furthermore, by separating the printing mechanism; the processing mechanism, and the memory device into individual components, each of the components can be reduced in size. Moreover, this contributes to cost reduction as well as enhancing the generalization of each component.

Furthermore, the personal computer may also function as the input unit and the information-writing unit.

Accordingly, since the input unit and the information-writing unit may be omitted from the printing mechanism, the overall structure can be simplified.

According to another aspect of the invention, a printing device functions as the printing mechanism included in the above-referenced printing/processing system.

In this case, the memory device is preferably included in the printing device, and the printing device preferably includes a communication unit that communicates with the processing mechanism.

Accordingly, since the print data and the process-specifying data based on the input printing information and the processing information, respectively, are printed on the processing sheet beforehand, the processing operation can be implemented afterwards by the processing mechanism. Moreover, an independent memory device is not necessary.

According to another aspect of the invention, a processing device functions as the processing mechanism included in the above-referenced printing/processing system.

In this case, the memory device is preferably included in the processing device, and the processing device preferably includes a communication unit that communicates with the printing mechanism.

Accordingly, by reading the process-specifying data printed on the processing sheet, the processing operation can be executed without requiring an input of information. Moreover, an independent memory device is not necessary.

According to another aspect of the invention, a printing/processing apparatus is provided with a single housing in which the printing mechanism, the processing mechanism, and the memory device included in the above-referenced printing/processing system are disposed. In this case, the printing operation and the processing operation are performed independently by the printing unit and the processing unit, respectively.

Accordingly, the printing operation and the processing operation can be performed using a single apparatus. Moreover, the printing operation and the processing operation can be performed independently instead of being performed consecutively. In this case, the term “independently” does not include the meaning of serial processing in which the printing operation and the processing operation are performed in a serial fashion nor the meaning of parallel processing in which the printing operation and the processing operation are performed in a parallel fashion.

According to another aspect of the invention, a program is provided for allowing a computer to implement the steps included in the above-referenced method for controlling the printing/processing system.

According to another aspect of the invention, a storage medium is provided which is computer-readable and stores the above-referenced program.

By implementing this program, the printing information and the processing information can be input and edited preliminarily, and the printing operation and the processing operation based on the printing information and the processing information can be performed independently in the printing mechanism and the processing mechanism, respectively.

### BRIEF DESCRIPTION OF THE DRAWINGS

The invention will be described with reference to the accompanying drawings, wherein like numbers reference like elements.

FIG. 1 is a functional block diagram of a label-making apparatus according to a first embodiment.

FIG. 2 is an external perspective view illustrating a state in which a cover of the label-making apparatus is closed.

FIG. 3 is an external perspective view illustrating a state in which the cover of the label-making apparatus is opened.

FIG. 4 is a schematic diagram illustrating a tape-conveying operation and a reading operation of a process-specifying code performed in a braille-embossing portion.

FIG. 5 is a control block diagram of the label-making apparatus.

FIG. 6 illustrates a memory portion.

FIG. 7 is a flow chart illustrating a printing operation performed in the label-making apparatus.

FIG. 8 is a flow chart illustrating an embossing operation performed in the label-making apparatus.

FIG. 9 is a functional block diagram of a label-making system according to a second embodiment.

FIG. 10 is a functional block diagram of a label-making system according to a third embodiment.

FIG. 11 is a functional block diagram of a label-making system according to a fourth embodiment.

FIG. 12 illustrates an example of a display screen of a display unit.

FIG. 13 is a functional block diagram of a label-making system according to a fifth embodiment.

FIG. 14 illustrates an internal configuration of a cutting device.

FIGS. 15A to 15C illustrate examples of a cutout label.

### DESCRIPTION OF EXEMPLARY EMBODIMENTS

A printing/processing system, a printing device, a processing device, a printing/processing apparatus, a method for controlling the printing/processing system, a program, and a storage medium according to embodiments of the present invention will be described below with reference to the attached drawings. In a printing/processing system having a printing mechanism, a processing mechanism, and a memory device according to an embodiment of the invention, a printing operation and a processing operation are performed separately on a processing sheet based on preliminarily input and edited printing information and processing information. Furthermore, process data generated based on the processing information is stored in the memory device beforehand so that the processing mechanism performs the processing operation by referring to the memory device. Thus, a processing operation requiring a large data volume can be performed. The printing/processing system according to the embodiment of the invention is, for example, directed to a label-making apparatus that performs a braille-embossing operation as the processing operation in order to produce a braille label having both braille characters recognizable by visually impaired persons and ink characters visibly recognizable by sighted persons on the same tape.

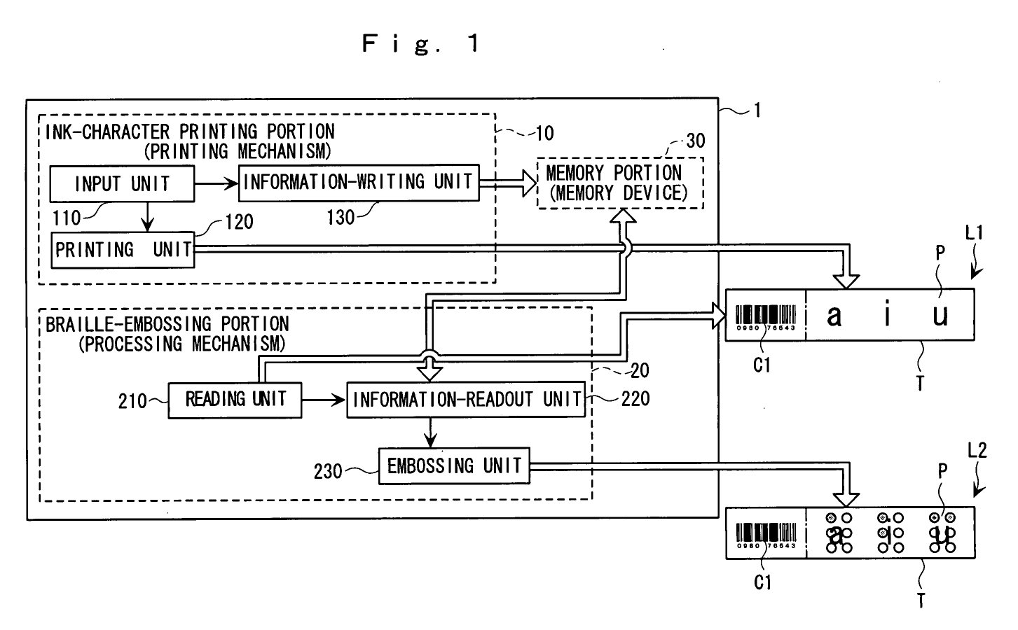

FIG. 1 is a functional block diagram of a label-making apparatus 1 according to a first embodiment. The label-making apparatus 1 includes an ink-character printing portion (printing mechanism) 10 that performs an ink-character printing operation on a tape T (processing sheet), a braille-embossing portion (processing mechanism) 20 that performs a braille-embossing operation on the printed tape T, and a memory portion (memory element) 30 into which the ink-character printing portion 10 writes information and from which the braille-embossing portion 20 reads information. The ink-character printing portion 10 mainly includes an input unit 110 for inputting information for performing a printing operation or an embossing operation, a printing unit 120 that performs a printing operation on the tape T based on the input to the input unit 110, and an information-writing unit 130 that writes emboss data into the memory portion 30. The emboss data is a control program and/or control data generated based on input information related with the embossing operation (which will be referred to as embossing information hereinafter).

The input unit 110 receives printing information for printing ink characters P on the tape T, and also receives the embossing information for allowing the braille-embossing portion 20 to perform the embossing operation. For example, as shown in FIG. 1, in a case where a braille label LB2 is to be made by printing a string of Japanese kana ink characters P for “a-i-u” and embossing corresponding braille characters B (i.e. a braille pattern based on braille translation corresponding to “a-i-u”) on the tape T, character information corresponding to the string of Japanese kana characters “a-i-u” is input as the printing information and the embossing information. In this case, the character information is common between the printing information and the embossing information. Alternatively, the printing information and the embossing information do not necessarily have to correspond to each other, such that different information may be input for the printing information and the embossing information.

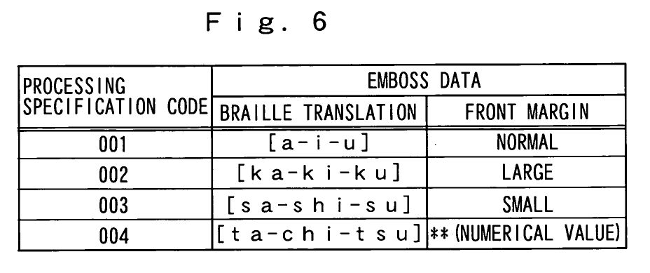

On the other hand, in addition to printing the print data (corresponding to the Japanese kana ink characters P for “a-i-u”) obtained by bit-mapping the printing information input to the input unit 110, the printing unit 120 prints a process-specifying code C1 (process-specifying data) for specifying the corresponding emboss data stored in the memory portion 30. After the printing operation, the tape T is cut to a predetermined length, thereby forming an ink-character label LB1. The information-writing unit 130 writes the emboss data and the process-specifying code C1 into the memory portion 30 in a manner such that the emboss data and the process-specifying code C1 correspond to each other. For example, referring to FIG. 6, in a case where a numerical value is used for each process-specifying code C1, the memory portion 30 stores a table in which each numerical value (which will be referred to as a specification number hereinafter) is set in correspondence with the corresponding emboss data. In this case, the term “process-specifying code C1” refers to a coded specification number, and is directed to a bar code in the first embodiment.

The emboss data contains braille data indicating braille characters B and data related with, for example, margins and braille positions in the width direction of the tape T. If the embossing positions are not selectable depending on the width of the tape T or the braille-embossing portion 20, the information related with the braille positions is not necessary. The braille data indicating the braille characters B is preferably single-byte data rather than image data (bit-mapped data) expressing a braille pattern. Specifically, the single-byte data indicates whether each of embossing points included in the braille characters B is to be embossed or not embossed using 1 or 0 (in a case where each braille character consists of six dots, the first and the last bits are not used). Accordingly, the data volume of the emboss data to be written into the memory portion 30 can be reduced.

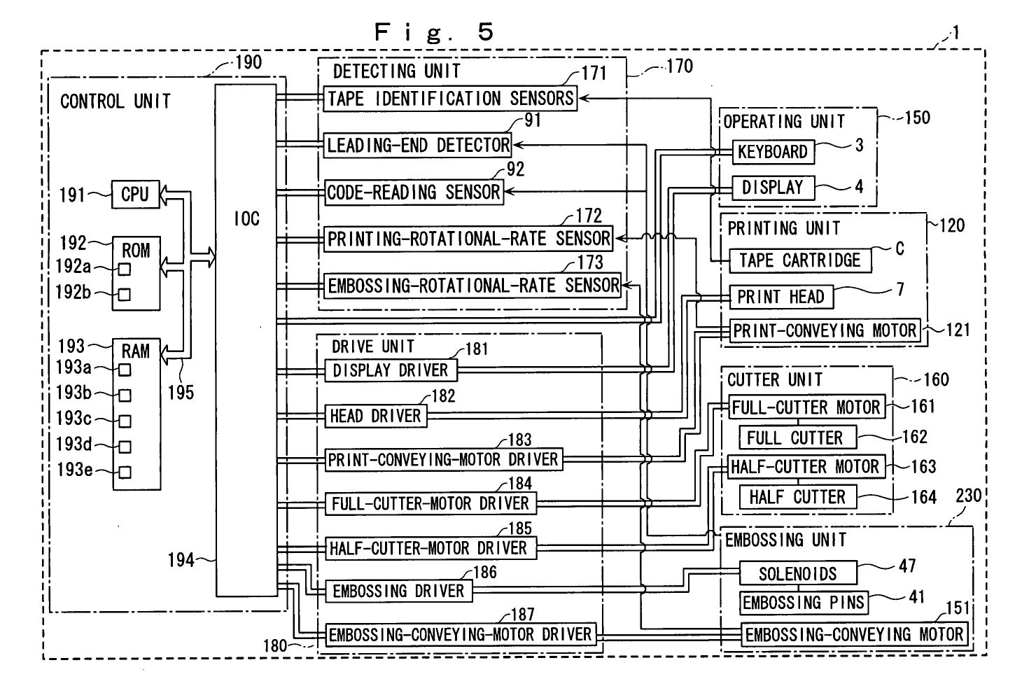

On the other hand, the braille-embossing portion 20 mainly includes a reading unit 210 that reads the process-specifying code C1 printed on the tape T in the ink-character printing portion 10, an information-readout unit 220 that refers to the memory portion 30 based on the read process-specifying code C1 and reads out the corresponding emboss data, and an embossing unit 230 that performs an embossing operation based on the read emboss data. The reading unit 210 includes a reflective image sensor (i.e. a code-reading sensor 92 shown in FIG. 5) that optically reads a subject (bar code), and a decoder (not shown) that decodes the read result of the image sensor.

The information-readout unit 220 obtains a specification number from the decoded result of the decoder, and refers to the memory portion 30 to read out the stored emboss data corresponding to the specification number. The embossing unit 230 embosses the corresponding braille characters B onto the tape T based on the read emboss data. As a result, the tape T embossed with these braille characters B becomes the braille label LB2, which is the end product.

Although a bar code is used for process-specifying code C1 in the first embodiment, an information-coded (encoded) mark or image may be used alternatively for the process-specifying code C1 in accordance with a desired symbol code system (symbology). Furthermore, as an alternative to bar codes, two-dimensional codes may be used. In that case, the two-dimensional codes may be, for example, QR codes, Maxi codes, Veri codes, data matrices, or PDF417.

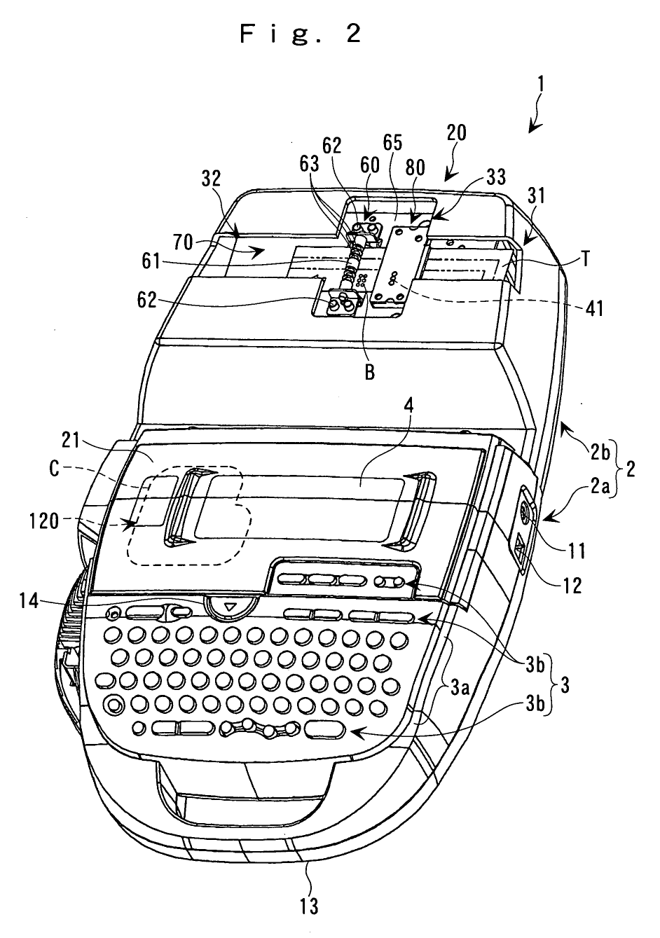

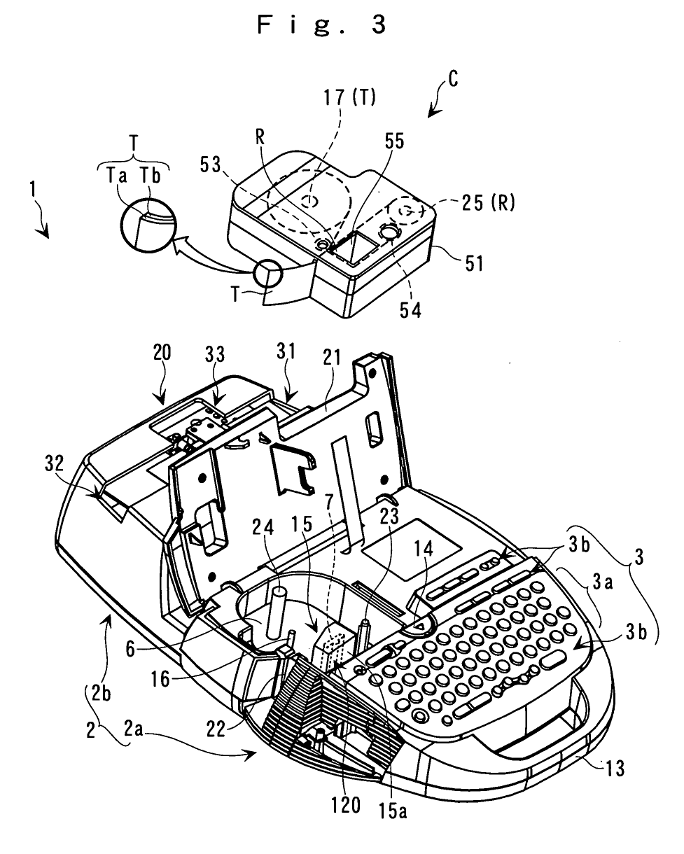

The structure of the label-making apparatus 1 will now be described with reference to FIGS. 2 and 3. FIG. 2 is an external perspective view illustrating a state in which a cover of the label-making apparatus 1 is closed. FIG. 3 is an external perspective view illustrating a state in which the cover of the label-making apparatus 1 is opened. As shown in these drawings, the frame of the label-making apparatus 1 is defined by a housing 2 having a handle 13. The housing 2 includes an anterior housing component 2a and a posterior housing component 2b which are integrated with each other. The anterior housing component 2a has the printing unit 120, which performs an ink-character printing operation on the tape T fed out from a tape cartridge C. On the other hand, the posterior housing component 2b has the braille-embossing portion 20, which performs a braille-embossing operation on the tape T fed manually into the braille-embossing portion 20 by a user.

An upper front surface of the anterior housing component 2a has a keyboard 3 disposed thereon, which functions as the input unit 110 (see FIG. 1). An upper rear surface of the anterior housing component 2a has an openable cover 21 attached thereto. The openable cover 21 is provided with a rectangular display 4. The left portion of the openable cover 21 is provided with a recess, which defines a cartridge-mounting portion 6 (corresponding to the printing unit 120 in FIG. 1) for holding the tape cartridge C. In a state where the openable cover 21 is opened by pressing a cover-opening button 14, the tape cartridge C is mounted into the cartridge-mounting portion 6 in a detachable fashion.

A right side portion of the anterior housing component 2a is provided with a power terminal 11 for receiving power, and a connection terminal 12 for connecting with an external device (not shown), such as a personal computer. By connecting an external device to the connection terminal 12, an ink-character printing operation or a braille-embossing operation can be performed based on printing information or embossing information generated by the external device.

A left side portion of the anterior housing component 2a is provided with a tape ejection slot 22 through which the cartridge-mounting portion 6 communicates with the outside. The tape ejection slot 22 has a full cutter 162 and a half cutter 164 (see FIG. 5) for cutting the tape T transferred from the printing unit 120. The full cutter 162 is for full-cutting a printed portion of the tape T after a printing operation. After an ink-character printing operation, the full-cut portion of the tape T is ejected through the tape ejection slot 22. On the other hand, the half cutter 164 is for cutting one of two layers of the tape T in the width direction of the tape T. The two layers included in the tape T will be described below in detail.

The keyboard 3 is provided with a character key group 3a and a function key group 3b for commanding, for example, various operation modes. The character key group 3a is for inputting printing information or embossing information and has a full key pattern based on Japanese Industrial Standards (JIS) key arrangement. The function key group 3b includes an execution key for executing an ink-character printing operation and/or a braille-embossing operation, a start transfer key for commanding the start of a transferring process of the tape T in the braille-embossing portion 20, an emboss start key for manually commanding a braille-embossing operation, and a mode selection key for selecting an operation mode for performing an ink-character printing operation and/or a braille-embossing operation.

The mode selection key allows for a selection between a first operation mode for performing the ink-character printing operation and the braille-embossing operation and a second operation mode for performing only the ink-character printing operation. If the second operation mode is selected, the process-specifying code C1 (see FIG. 1) for specifying the corresponding emboss data is not printed. This embodiment will mainly be directed to a case where the first operation mode is selected.

The display 4 has a shape of a rectangle with a size of about 12 cm in the horizontal direction (x-axis direction) by about 5 cm in the vertical direction (y-axis direction). In this rectangle, the display 4 is capable of displaying 192-dot×80-dot image data. The user can input information through the keyboard 3 in order to check the image of the end product (ink-character label LB1 or braille label LB2) on the display 4 or edit the input information. Moreover, the display 4 also informs the user by displaying various types of errors and messages (directions).

The cartridge-mounting portion 6 includes a head unit 15 having a head cover 15a in which a print head 7 formed of a thermal head is disposed, a platen drive shaft 16 facing the print head 7, a winding drive shaft 23 for winding an ink ribbon R, and a positioning projection 24 for a tape reel 17. A printing-conveying motor 121 (see FIG. 5) for rotating the platen drive shaft 16 and the winding drive shaft 23 is embedded in the bottom of the cartridge-mounting portion 6.

The tape cartridge C includes a cartridge casing 51. An upper central section of the cartridge casing 51 houses the tape reel 17 around which the tape T having a fixed width is wound, and a lower right section of the cartridge casing 51 houses a ribbon wheel 25 around which the ink ribbon R is wound. The tape T and the ink ribbon R have the same width. A lower left section adjacent to the tape reel 17 is provided with a through hole 55 through which the head cover 15a covering the head unit 15 extends. A platen roller 53 engaged to and rotated by the platen drive shaft 16 is disposed at a position where the tape T and the ink ribbon R overlap. On the other hand, a ribbon-winding reel 54 is disposed adjacent to the ribbon wheel 25. The ink ribbon R unwound from the ribbon wheel 25 extends around the head cover 15a so as to be taken up by the ribbon-winding reel 54.

The tape T includes a base sheet (information-formation layer) Ta having an adhesive layer on a rear surface thereof, and a release sheet (release layer) Tb attached to the base sheet Ta via the adhesive layer. The base sheet Ta is a multilayer laminate including an image reception layer that allows for high fixation of ink thermally-transferred from the ink ribbon R, a base layer formed of a polyethylene terephthalate (PET) film and defining the main portion of the base sheet Ta, and the adhesive layer composed of an adhesive in that order from the front surface of the base sheet Ta. On the other hand, the release sheet Tb is provided for preventing, for example, foreign particles from adhering to the adhesive layer before the base sheet Ta is used as a label. The release sheet Tb is composed of, for example, woodfree paper having a siliconized surface. The term “half cut” mentioned above refers to cutting only the base sheet Ta of the laminated base sheet Ta and release sheet Tb in the width direction of the tape T so that the release sheet Tb can be peeled off readily.

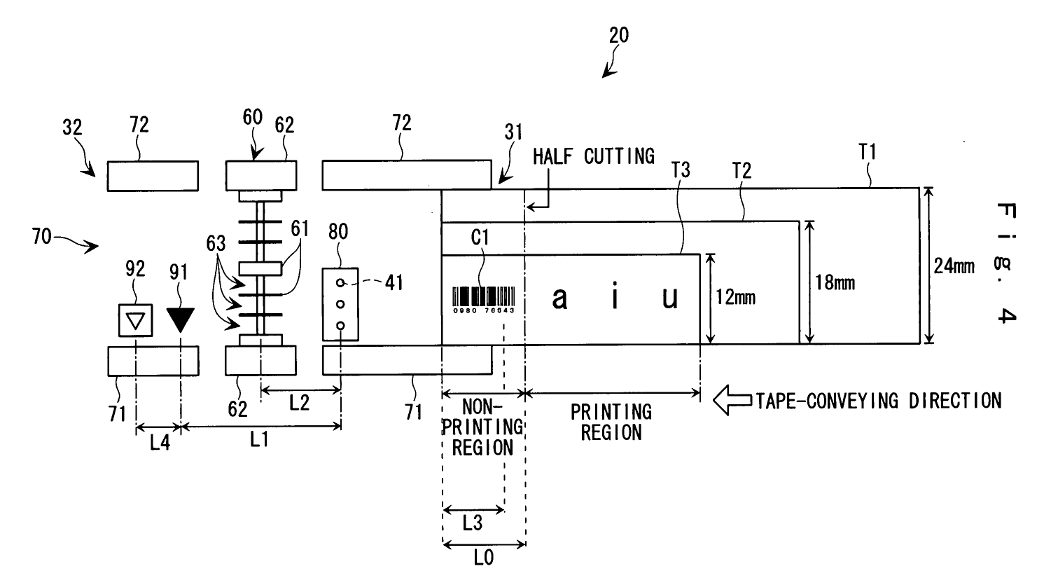

The tape T is preliminarily selected from a plurality of tape types classified in accordance with, for example, tape width, tape color, ink color, and tape material. A plurality of holes (not shown) for indicating these tape types is provided in the undersurface of the cartridge casing 51. The cartridge-mounting portion 6 is provided with a plurality of tape identification sensors (micro-switches) 171 (see FIG. 5) in correspondence with the plurality of holes. The tape identification sensors 171 detect the holes. Accordingly, by detecting the condition of each of the tape identification sensors 171, the corresponding tape type can be determined. Referring to FIG. 4, the description below is directed to three examples of tape types, which are a tape T1 having a width of 24 mm, a tape T2 having a width of 18 mm, and a tape T3 having a width of 12 mm.

The posterior housing component 2b has an assembly (braille-embossing portion 20) built therein for performing braille-embossing. The upper surface of the posterior housing component 2b has a cross-shaped opening 33 through which the braille-embossing portion 20 is exposed. The right side of the opening 33 is provided with a tape insertion slot 31 through which the tape T can be inserted manually by the user. The left side of the opening 33 is provided with a tape ejection slot 32 through which the braille-embossed tape T is ejected.

The braille-embossing portion 20 includes an embossing unit 80 for performing braille-embossing with three embossing pins 41 driven by a solenoid 47 (see FIG. 5), a tape-conveying mechanism 60 that conveys the tape T inserted through the tape insertion slot 31 towards the tape ejection slot 32, and a tape-traveling path 70 along which the tape T is conveyed. The embossing unit 80 selectively drives the three embossing pins 41 against the tape T conveyed along the tape-traveling path 70 in response to the driving of the tape-conveying mechanism 60, whereby each braille character B is formed.

The tape-conveying mechanism 60 includes a conveying roller 61 which is rotatable in the forward and reverse directions, a supporting member 62 that supports the conveying roller 61 against a frame 65, and an embossing-conveying motor 151 (see FIG. 5). The conveying roller 61 has a total of six annular grooves 63 (see FIG. 4) three of which are arranged in the upper section of the conveying roller 61 and the other three of which are arranged in the lower section of the conveying roller 61 with respect to the width direction of the tape-traveling path 70. The three annular grooves 63 in each section of the conveying roller 61 are prevented from interfering with the three embossed points in each row so as to prevent the embossed braille characters B from being flattened.

The embossing unit 80 is opposed to the undersurface of the tape T and includes an embossing member (embossing head) containing the three embossing pins 41, and an emboss-receiving member which faces the embossing member across the tape T. The embossing unit 80 is fixed in position at a lower section of the tape-traveling path 70 with respect to the width direction thereof. Accordingly, when the braille-embossing operation is performed on the tape T1 having the largest width (24 mm), the braille characters B are embossed in the lower half portion of the tape T1 with respect to the width direction thereof (see FIG. 4).

Referring to FIG. 4, the tape-conveying operation and the reading operation of the process-specifying code C1 performed in the braille-embossing portion 20 will be described. As described above, the braille-embossing portion 20 includes the embossing unit 80 having the embossing pins 41 that form embossed protrusions on the tape T, the tape-traveling path 70 along which the tape T is conveyed, and the tape-conveying mechanism 60 that conveys the tape T along the tape-traveling path 70. In addition to these components, the braille-embossing portion 20 further includes guide members 71, 72 for guiding the tape T being conveyed, a transmissive leading-end detector 91 that detects the leading end of the tape T, and the code-reading sensor 92 that reads the process-specifying code C1.

As mentioned above, the leading end portion of the tape T is subject to half-cutting by the ink-character printing portion 10 so that the release sheet Tb can be peeled off readily. As shown in FIG. 4, due to the half-cutting treatment, the tape T is divided into a non-printing region (discarding portion) disposed proximate the leading end of the tape T and a printing region disposed proximate the trailing end of the tape T. In this case, the term “non-printing region” refers to a region in which the ink characters P (print data) are not printed, whereas the term “printing region” refers to a region in which the ink characters P are printed (i.e. a region to be used as a label). Furthermore, the non-printing region has a fixed length L0 in the tape-conveying direction regardless of the tape width. The process-specifying code C1 is printed in the non-printing region at a predetermined position with respect to the tape-conveying direction and the tape-width direction. In other words, although FIG. 4 only illustrates the process-specifying code C1 printed on the tape T3, the process-specifying code C1 with the same size is similarly printed in the same position for each of the tape T1 and the tape T2. The process-specifying code C1 can thus be read by the code-reading sensor 92, which is fixed in position (in a case where the tape T1 or the tape T2 is used, the process-specifying code C1 is printed in the lower half section of the non-printing region of the tape). Moreover, because the process-specifying code C1 is printed in the non-printing region, the visibility of the printing region is prevented from being impaired.

Of the tapes T1, T2, and T3, the tape T1 with the largest width is guided by the upper and lower guide members 71, 72. On the other hand, the two remaining tapes T2, T3 are guided solely by the lower guide member 71. For example, if the tape T3 with the smallest width is used, the user may manually insert the tape T3 (i.e. the ink-character label LB1) along the lower guide member 71 until the leading end of the tape T3 reaches the tape-conveying mechanism 60 (the conveying roller 61). Subsequently, by pressing the start transfer key on the keyboard 3, the tape-conveying mechanism 60 starts the conveying operation of the tape T3. The leading-end detector 91 then detects the leading end of the tape T3. When the leading end of the tape T3 is detected, the code-reading sensor 92 subsequently reads (detects) the process-specifying code C1.

The reading of the process-specifying code C1 is performed simultaneously with the transferring of the tape (i.e. the transferring of the tape in the forward direction) by a predetermined distance in which the process-specifying code C1 is detectable. (For example, this distance is the sum of a length L3 extending from the leading end of the tape T to the rear end of the process-specifying code C1 in the tape-conveying direction, a length L4 between the leading-end detector 91 and the code-reading sensor 92, and a predetermined length set in view of a detection error.) In a case where the length of a front margin extending from the leading end of the tape T to the first embossing row (embossing start position) is set shorter than the sum of a length L1 between the embossing unit 80 (the embossing pins 41) and the leading-end detector 91, the length L3, and the length L4 (in this case, the length of the front margin is assumed to be set longer than a length L2 between the embossing unit 80 and the conveying roller 61 in view of the positioning of the conveying roller 61), the conveying roller 61 may be rotated in the reverse direction so that the tape T is conveyed backwards. When the tape T is conveyed backward to an appropriate position, the embossing operation and the forward conveying operation of the tape T are started. The braille-embossing operation and the tape-conveying operation are performed based on the emboss data and a detection result of an embossing-rotational-rate sensor 173 (see FIG. 5) that detects the rotation of the embossing-conveying motor 151 driving the tape-conveying mechanism 60.

When the embossing operation is completed, the tape-conveying mechanism 60 conveys the tape by a distance corresponding to the length of a rear margin extending from the last embossing row (embossing end position) to the trailing end of the tape T. Thus, the tape T (i.e. the braille label LB2) is ejected from the tape ejection slot 32. The embossing operation by the embossing unit 80 does not necessarily have to be triggered in response to the detection of the leading end of the tape T by the leading-end detector 91, and may alternatively be started manually by the user by pressing the emboss start key provided on the keyboard 3.

Referring to FIG. 5, a control system of the label-making apparatus 1 will be described. The label-making apparatus 1 mainly includes an operating unit 150, the printing unit 120, a cutting unit 160, the embossing unit 230, a detecting unit 170, a driving unit 180, and a control unit 190. Specifically, the operating unit 150 is for controlling a user interface, such as information input by the user or display of various types of information, and has the keyboard 3 (corresponding to the input unit 110 in FIG. 1) and the display 4. The printing unit 120 has the tape cartridge C, the print head 7, and the printing-conveying motor 121, and prints print data on the tape T while feeding the tape T and the ink ribbon R. The cutting unit 160 cuts the printed tape T to a predetermined length, and has the full cutter 162, the half cutter 164 (half-cutting unit), a full-cutter motor 161 for driving the full cutter 162, and a half-cutter motor 163 for driving the half cutter 164. The embossing unit 230 has the solenoid 47, the embossing pins 41, and the embossing-conveying motor 151, and embosses the tape T with emboss data based on embossing information while conveying the tape T. The detecting unit 170 performs various detections and has the tape identification sensors 171 for detecting the type of tape T (tape cartridge C), the leading-end detector 91 provided in the braille-embossing portion 20 for detecting the leading end of the tape T, the code-reading sensor 92 (corresponding to the reading unit 210 in FIG. 1) provided in the braille-embossing portion 20 for reading the process-specifying code C1 printed on the tape T, a printing-rotational-rate sensor 172 for detecting the rotational rate of the printing-conveying motor 121, and the embossing-rotational-rate sensor 173 for detecting the rotational rate of the embossing-conveying motor 151. The driving unit 180 is for driving the corresponding units and has a display driver 181, a head driver 182, a printing-conveying-motor driver 183, cutter-motor drivers 184, 185, an embossing driver 186, and an embossing-conveying-motor driver 187. The control unit 190 is connected to each unit and controls the entire label-making apparatus 1.

The control unit 190 includes a CPU 191, a ROM 192, a RAM 193, and an input-output controller (which will be referred to as an IOC hereinafter) 194, which are connected to one another via an internal bus 195. The ROM 192 includes a control program block 192a and a control data block 192b. The control program block 192a stores various control programs to be used by the CPU 191 for performing control operations. The programs are for performing, for example, the printing and embossing operations and also for printing the process-specifying code C1 (bar code). The control data block 192b stores various types of control data including, for example, character-font data for the ink-character printing operation and braille-pattern data for the braille-embossing operation.

The RAM 193 includes a work-area block 193a used as, for example, a flag, a print-data block 193b for storing print data (bit-mapped data), a process-specifying-code block 193c for storing bit-mapped data used for printing a process-specifying code C1, an emboss-data block 193d (memory portion 30) for storing emboss data and a process-specifying code C1 in correspondence with each other, and a decoded-result block 193e for storing a decoded result (specification number) of data read by the code-reading sensor 92. The RAM 193 is thus used as a work area for control operations. Furthermore, the RAM 193 is backed up regularly so that the stored data is maintained even when the power is shut off.

The IOC 194 has a logical circuit disposed therein, which is provided as a supplement for the function of the CPU 191 and also for managing interface signals with respect to various peripheral circuits. The logical circuit may be defined by, for example, a gate array or custom LSI. Accordingly, the IOC 194 sends input data or control data received from the keyboard 3 directly to the internal bus 195 or sends the data to the internal bus 195 after processing the data. Moreover, in conjunction with the CPU 191, the IOC 194 receives data or a control signal output to the internal bus 195 from the CPU 191, and outputs the data or the control signal directly to the driving unit 180 or outputs the data or the control signal after processing the data or the control signal.

In accordance with the corresponding control program in the ROM 192, the CPU 191 receives the corresponding signal or data from each unit included in the label-making apparatus 1 via the IOC 194. Based on the input signal or data, various types of data in the RAM 193 are processed. The CPU 191 then outputs the corresponding signal or data to each unit included in the label-making apparatus 1 via the IOC 194 so as to, for example, control the printing operation or the embossing operation. Furthermore, referring to FIG. 1, the CPU 191 also functions as the information-writing unit 130 that writes emboss data in the emboss-data block 193d, and as the information-readout unit 220 that reads out emboss data from the emboss-data block 193d.

Referring to FIG. 6, the information stored in the emboss-data block 193d (memory portion 30) will be described. Here, the content of the emboss data items stored in correspondence with the process-specifying codes C1 will be described simply in a table fashion by referring only to the information related with the braille translation and the front margin. For example, as shown in FIG. 6, in a case where the process-specifying code C1 read out by the CPU 191 indicates a specification number “001”, the corresponding emboss data item having the content that indicates the embossing of braille characters B based on the braille translation for the Japanese kana characters “a-i-u” with a “normal” front margin (corresponding to a distance by which the tape is conveyed to the first embossing row) is read out. The control operation is performed based on this emboss data item. On the other hand, in a case where the process-specifying code C1 indicates a specification number “002”, the CPU 191 controls the embossing operation such that braille characters B based on the braille translation for Japanese kana characters “ka-ki-ku” are embossed with a “large” front margin. Accordingly, the emboss data is temporarily stored in the emboss-data block 193d, and the emboss data corresponding to the read process-specifying code C1 is read out based on the process-specifying code C1. Therefore, the control information itself does not need to be included in the process-specifying code C1, meaning that the data volume of the process-specifying code C1 is reduced. Accordingly, a bar code, which has a relatively small memory size, can be used as the process-specifying code C1 (see FIG. 1), whereby the structure of the code-reading sensor 92 can be simplified.

FIG. 1 illustrates an example of a label in which the Japanese kana ink characters P for “a-i-u” and the braille characters B for “a-i-u” are overlapped with each other (the front margin for the ink characters P and the front margin for the braille characters B are both set to “normal”). On the other hand, if the front margin for the braille characters B is set to “large”, the embossing operation is started from a point closer towards the trailing end in comparison to the starting point shown in FIG. 1 (for example, from an overlapping point with respect to the ink character P “i”). Moreover, when the front margin for the braille characters B is set to “large”, the ink-character label LB1 is given a longer rear margin so that the braille characters B can fit in the tape length shown in FIG. 1.

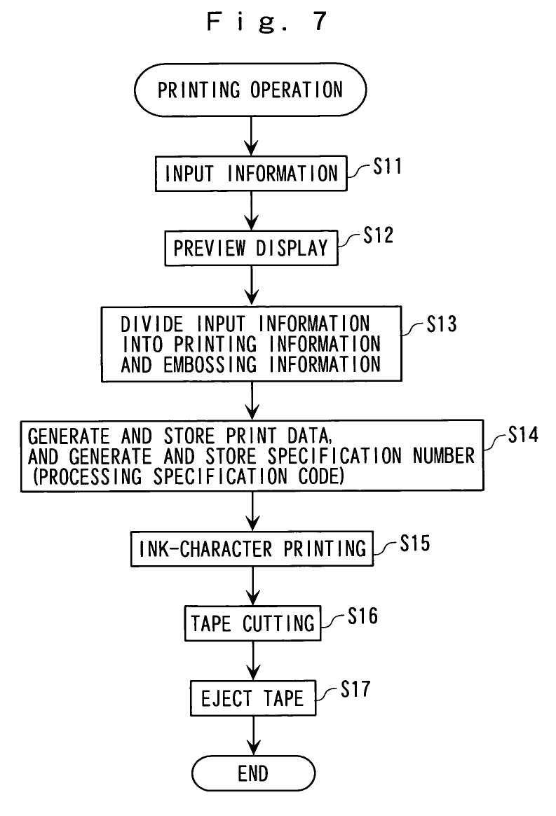

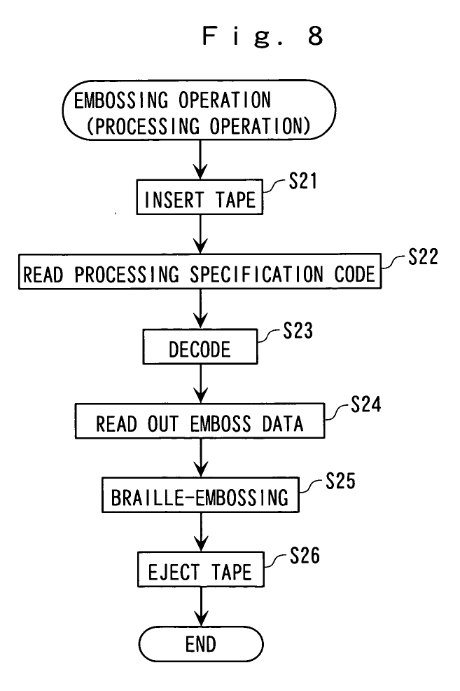

The printing operation and the embossing operation executed mainly by the CPU 191 will now be described with reference to FIGS. 7 and 8. FIG. 7 is a flow chart of the printing operation, and FIG. 8 is a flow chart of the embossing operation. Referring to FIG. 7, in the printing operation, information is first input through the keyboard 3 in step S11. In step S12, a preview display is implemented based on the input information, such that a final image of the braille label LB2 to be made (see FIG. 1) is displayed on the display 4. Subsequently, the user may check the preview display, edit the information where necessary, and then input the information (send a command (i.e. an execution command for the first operation mode) for making the braille label LB2 through the keyboard 3). In step S13, the input information is divided into printing information for the ink-character printing operation and embossing information for the braille-embossing operation. Alternatively, in a case where the information is input separately by switching between the printing mode and the embossing mode, step S13 may be omitted.

In step S14, print data is generated based on the printing information and is stored temporarily in the print-data block 193b, and moreover, emboss data is also generated based on the embossing information and is stored temporarily in the emboss-data block 193d. Furthermore, a specification number is generated automatically based on, for example, the corresponding memory address in the table, and moreover, bit-mapped data for printing a bar-coded process-specifying code C1, which corresponds to the specification number, is generated. The bit-mapped data is stored temporarily in the process-specifying-code block 193c.

When the data is generated and stored, the operation proceeds to step S15. In step S15, the printing-conveying motor 121 is driven and the print head 7 is driven based on the detection result of the printing-rotational-rate sensor 172, whereby the ink-character printing operation is performed based on the print data in the print-data block 193b. In this case, the process-specifying code C1 is also printed together with the print data. Subsequently, in step S16, the tape is conveyed by the distance corresponding to the length of the rear margin based on the print data so that the trailing end of the tape is cut with the full cutter 162. In step S17, the tape T (ink-character label LB1) is ejected through the tape ejection slot 22.

Referring to FIG. 8, the embossing operation will now be described. In step S21, the tape T (i.e. the ink-character label LB1) cut into a rectangle is inserted manually into the tape insertion slot 31 by the user. In step S22, the embossing-conveying motor 151 is driven based on the detection result of the embossing-rotational-rate sensor 173, whereby the tape T is conveyed. The code-reading sensor 92 then reads the process-specifying code C1. In step S23, the read result is decoded. In step S24, based on the decoded result indicating the specification number, the corresponding emboss data is read out by referring to the emboss-data block 193d. In step S25, the braille-embossing operation is performed by driving the solenoid 47 based on the emboss data. In step S26, after the embossing operation is completed, the tape T is conveyed by the distance corresponding to the length of the rear margin based on the emboss data so that the tape T (i.e. the braille label LB2) is ejected through the tape ejection slot 32.

As described above, according to the first embodiment, in the ink-character printing portion 10, the print data based on the input printing information and the process-specifying code C1 for specifying the corresponding emboss data to be processed in the braille-embossing portion 20 are printed together on the tape T. Consequently, in the braille-embossing portion 20, the printed process-specifying code C1 is read so that the embossing operation can be performed by referring to the memory portion 30. In other words, two operations can be performed in a single apparatus, and moreover, the printing information and the embossing information can be input and edited preliminarily, and the operations based on the printing information and the embossing information can be performed independently in the ink-character printing portion 10 and the braille-embossing portion 20. Accordingly, the label-making operation may be temporarily discontinued (by shutting off the power) after the completion of the ink-character printing operation, and in that case, the braille-embossing operation may be performed at a later time. Moreover, in a case where a plurality of braille labels having different contents is to be made, the ink-character printing operation may be performed first to produce a bundle of ink-character labels LB1, and the embossing operation may be performed subsequently on the bundle of ink-character labels LB1 to produce braille labels LB2.

Furthermore, since the operation shown in FIG. 7 and the operation shown in FIG. 8 are performed independently, the complex structure and bad usability seen in apparatuses that perform the two operations in a serial fashion or a parallel fashion are prevented. For example, if the label-making apparatus 1 according to the first embodiment supposedly does not print the process-specifying code C1 in the ink-character printing portion 10, the printing operation and the embossing operation are performed in a serial fashion. This means that the printing operation and the embossing operation must be performed consecutively. In that case, if a wrong label is mistakenly inserted into the braille-embossing portion 20 (if a label other than the ink-character label produced just before the embossing operation is inserted), a defective label is produced in which the printed ink characters and the embossed braille characters do not match with each other. In contrast, according to the first embodiment, the process-specifying code C1 is printed on the tape T so that the embossing operation is performed based on the read result of the process-specifying code C1. Accordingly, a braille label LB2 desired by the user can be produced.

Furthermore, the control information for performing the embossing operation does not need to be included in the process-specifying code C1 since only the information for specifying the content of the embossing operation needs to be printed as the process-specifying code C1. Accordingly, the data for the process-specifying code C1 is simplified. This simplifies the structure of the reading unit 210 as well as preventing false operation caused by a misreading of the code by the reading unit 210. Moreover, the contents of the operations are prevented from being limited by the containable data volume of the process-specifying code C1.

Furthermore, since the process-specifying code C1 is printed in the non-printing region formed by half-cutting, the visibility of the printing region of print data, for example, is prevented from being impaired. This prevents the end product from being adversely affected. Moreover, the half-cutting treatment allows the release sheet Tb to be peeled off readily from the base sheet Ta.

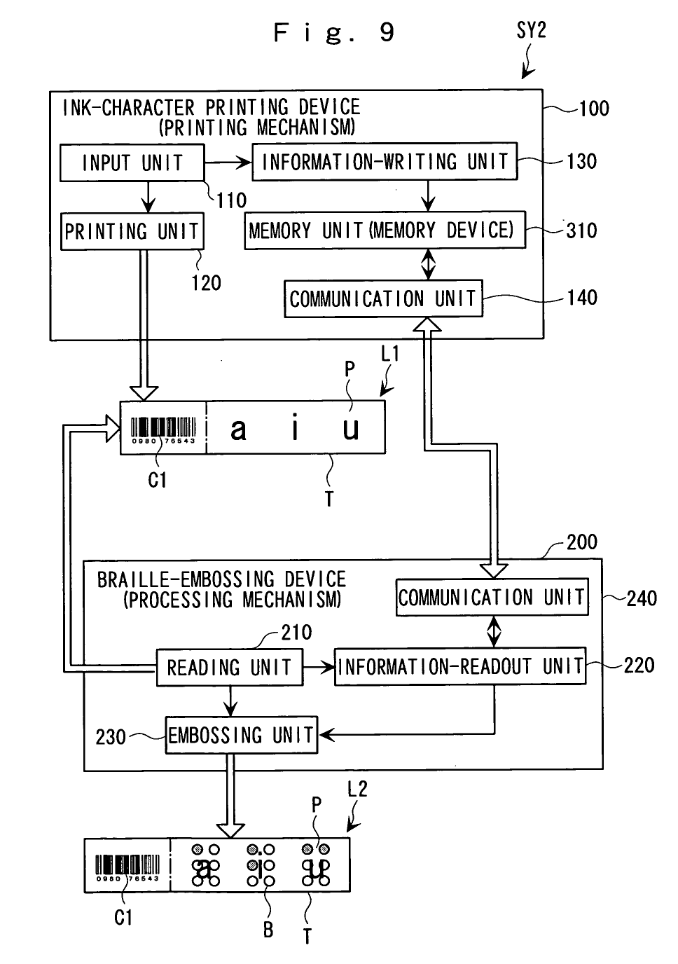

A second embodiment of the invention will now be described with reference to FIG. 9. In the first embodiment described above, the ink-character printing portion 10, the braille-embossing portion 20, and the memory portion 30 are contained in a single housing (i.e. the housing 2 shown in FIG. 2) of the label-making apparatus 1. In contrast, according to the second embodiment, two independent devices are provided, which are an ink-character printing device 100 including the ink-character printing portion 10 and the memory portion 30, and a braille-embossing device 200 including the braille-embossing portion 20. These two devices form a label-making system SY2. The label-making system SY2 according to the second embodiment will be described below by focusing on the differences from the first embodiment.

FIG. 9 is a functional block diagram of the label-making system SY2 according to the second embodiment. As shown in FIG. 9, the label-making system SY2 according to the second embodiment mainly includes the ink-character printing device 100 and the braille-embossing device 200. Specifically, the ink-character printing device 100 includes the input unit 110, the printing unit 120, the information-writing unit 130, a memory unit 310 functioning as the memory portion 30, and a communication unit 140 that communicates with the braille-embossing device 200. On the other hand, the braille-embossing device 200 includes the reading unit 210, the information-readout unit 220, the embossing unit 230, and a communication unit 240 that communicates with the ink-character printing device 100. The ink-character printing device 100 corresponds to the anterior housing component 2a shown in FIG. 2, whereas the braille-embossing device 200 corresponds to the posterior housing component 2b shown in FIG. 2. Therefore, a detailed description of the configuration of the system will be omitted.

In the ink-character printing device 100, the information-writing unit 130 writes emboss data, which is generated based on embossing information input to the input unit 110, into the memory unit 310. Furthermore, a process-specifying code C1, which is a coded specification number for specifying the emboss data, and the print data generated based on the input printing information are printed on the tape T by the printing unit 120.

On the other hand, when the embossing operation is to be performed, the user may first connect the ink-character printing device 100 and the braille-embossing device 200 via, for example, a cable. Subsequently, when the tape T (i.e. the ink-character label LB1) is inserted into the braille-embossing device 200, the reading unit 210 of the braille-embossing device 200 reads the process-specifying code C1 printed on the tape T. Based on the specification number, which is a decoded result of the process-specifying code C1, the information-readout unit 220 reads out the corresponding emboss data from the memory unit 310 via the communication units 240, 140. Based on the read emboss data, the embossing unit 230 performs the braille-embossing operation, whereby a braille label LB2 is produced.

According to the second embodiment, the printing operation and the embossing operation are performed in separate devices that are independent of each other. Consequently, this achieves size reduction of the devices as well as contributing to cost reduction. Moreover, this enhances the generalization of the devices. In other words, a user that normally desires only ink-character printing may purchase only the ink-character printing device 100, and may, for example, borrow the braille-embossing device 200 from another user and connect the braille-embossing device 200 to the ink-character printing device 100 when the user desires to make braille labels LB2. Furthermore, when performing the braille-embossing operation, the tape T may simply be inserted into the tape insertion slot 31 (see FIG. 2) without requiring a complicated operation. This provides easy operation for users that are not accustomed to operating these devices.

As an alternative to the braille-embossing device 200 shown in FIG. 9 in which the structure thereof is simple, the braille-embossing device 200 may additionally be provided with the input unit 110 so that the braille-embossing device 200 is capable of performing the braille-embossing operation independently. Furthermore, the braille-embossing device 200 may additionally be provided with a display unit so that a preview of the embossed result is displayed on the display unit based on the read result of the emboss data. In that case, the user may select whether or not to actually execute the embossing operation based on the preview display.

As a further alternative, the generation of the emboss data based on the input embossing information may be implemented in the braille-embossing device 200 instead of the ink-character printing device 100. In that case, the ink-character printing device 100 may store the input embossing information as, for example, a braille code so that the braille code is sent directly to the braille-embossing device 200. Accordingly, this reduces the control load of the ink-character printing device 100.

Furthermore, instead of connecting the ink-character printing device 100 and the braille-embossing device 200 with a cable, the ink-character printing device 100 and the braille-embossing device 200 may alternatively be connected to each other by wireless connection using, for example, infrared communication or Bluetooth®.

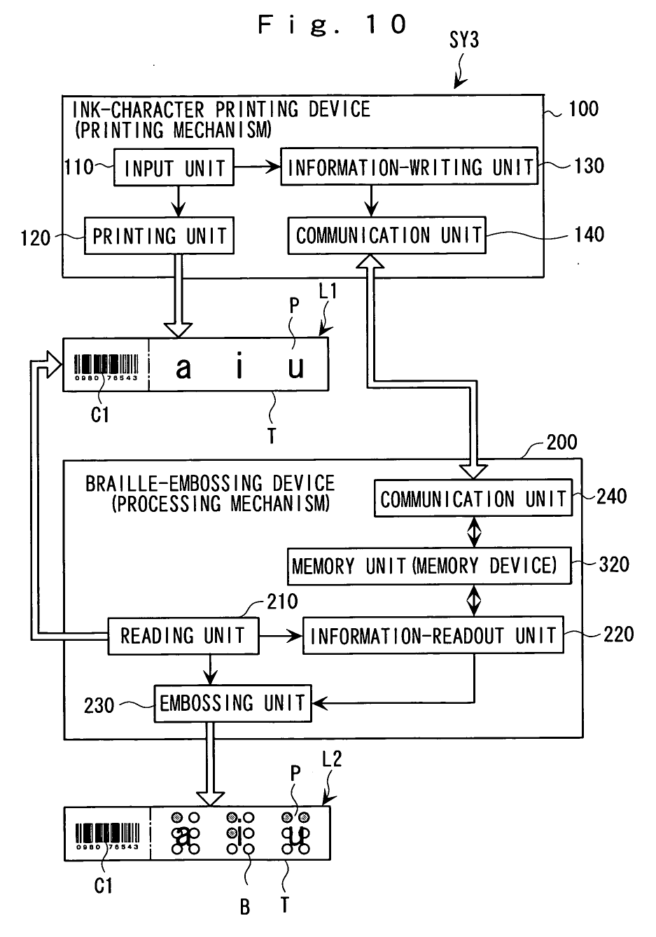

A third embodiment of the invention will now be described with reference to FIG. 10. In the second embodiment described above, the ink-character printing device 100 is provided with the memory unit 310. In contrast, according to the third embodiment, a memory unit 320 is provided in the braille-embossing device 200. In other words, in the third embodiment, the user preliminarily connects the ink-character printing device 100 and the braille-embossing device 200 via, for example, a cable before the printing operation. In the ink-character printing device 100, the information-writing unit 130 writes emboss data, which is generated based on input embossing information, into the memory unit 320 included in the braille-embossing device 200 via the communication units 140, 240. On the other hand, the braille-embossing device 200 reads out the emboss data from the memory unit 320 in order to perform the braille-embossing operation.

Similar to the second embodiment, the printing operation and the embossing operation are performed in separate devices that are independent of each other in the third embodiment. This achieves size reduction of the devices as well as contributing to cost reduction. Moreover, when the embossing operation is to be performed, the two devices do not need to be connected to each other. Therefore, by preliminarily sending the emboss data to the braille-embossing device 200, the braille label LB2, which is the end product, can be produced independently by the braille-embossing device 200.

Similar to the second embodiment, the braille-embossing device 200 may additionally be provided with the input unit 110 and a display unit. Furthermore, the emboss data may be generated in the braille-embossing device 200 by receiving, for example, a braille code from the ink-character printing device 100. In this case, the emboss data is similarly stored in the memory unit 320.

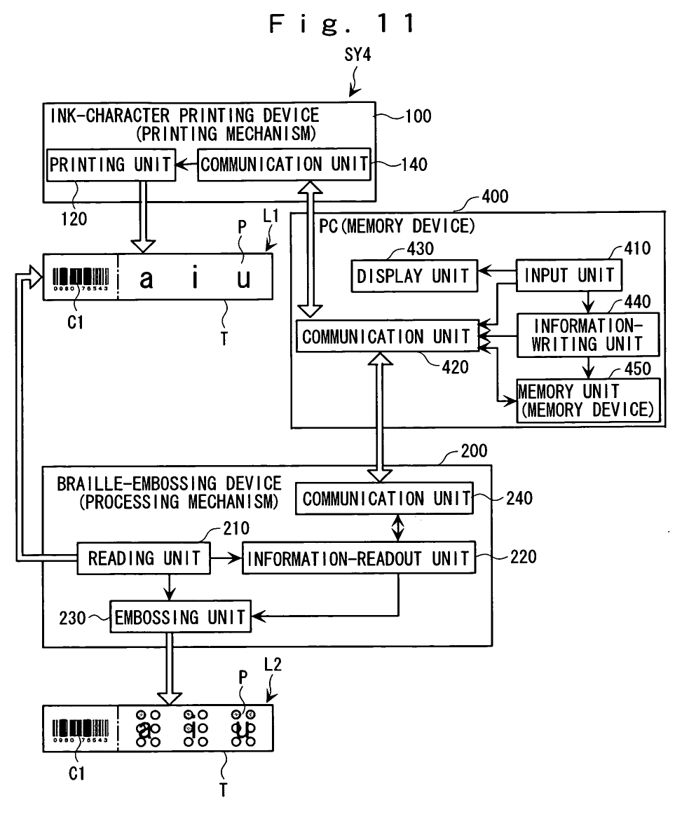

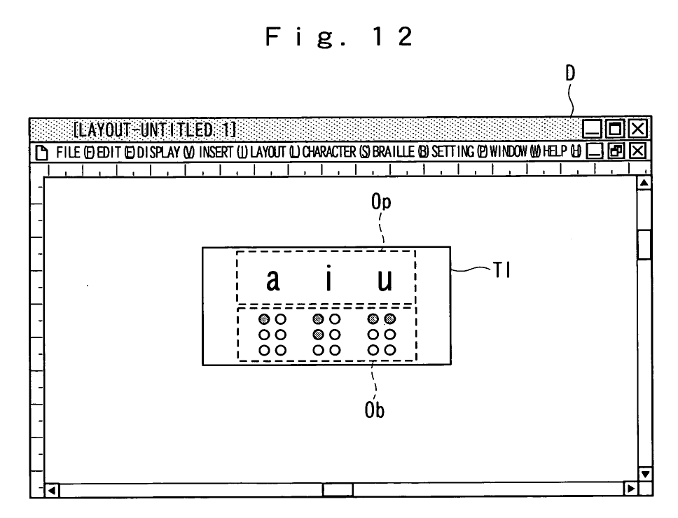

A fourth embodiment of the invention will now be described with reference to FIGS. 11 and 12. In each of the second and third embodiments described above, the memory unit 310 or 320 is provided in the ink-character printing device 100 or the braille-embossing device 200. In contrast, in the fourth embodiment, the memory unit is incorporated into a personal computer 400 (which will simply be referred to as PC hereinafter). The PC 400 also functions as the input unit 110 for inputting the printing information and the embossing information. The fourth embodiment will be described below by focusing on the differences from the above embodiments.

Referring to FIG. 11, a label-making system SY4 according to the fourth embodiment mainly includes the ink-character printing device 100, the braille-embossing device 200, and the PC 400. Specifically, the ink-character printing device 100 includes the printing unit 120 and the communication unit 140. The braille-embossing device 200 includes the reading unit 210, the information-readout unit 220, the embossing unit 230, and the communication unit 240. The PC 400 includes an input unit 410, a communication unit 420, a display unit 430 (i.e. a display screen D shown in FIG. 12), an information-writing unit 440, and a memory unit 450. A support software program (application) for designing the layout for the ink-character label LB1 and braille label LB2 and a driver for controlling the ink-character printing device 100 and the braille-embossing device 200 are preinstalled in the PC 400.

In this case, as shown in FIG. 12, an image TI (which will be referred to as a tape image hereinafter) of the printing region of the tape T is displayed on the display screen D, and moreover, an ink-character object Op indicating the printing content and a braille object Ob indicating the embossing content are set in the tape image TI. The user may shift and position each of the objects Op, Ob so as to design the layout of the braille label LB2. Based on the layout, the PC 400 generates the print data and the emboss data. In other words, the PC 400 generates the print data based on the content and the position of the ink-character object Op, and also generates the emboss data based on the content and the position of the braille object Ob. In a case where a text string can be input directly into the tape image TI, the print data also contains data related to the content and the position of the directly-input text string in addition to the data related to the ink-character object Op.

The printing operation performed in the label-making system SY4 will now be described. Based on the printing information and the embossing information input to the input unit 410, the PC 400 implements a preview display of the braille label LB2 on the display screen D (see FIG. 12). While checking the display, the printing information and the embossing information may be edited. Furthermore, the information-writing unit 440 writes the emboss data generated based on the embossing information into the memory unit 450 in correspondence with an automatically-generated specification number. Furthermore, the print data generated based on the printing information input to the input unit 410 and the specification number written in the memory unit 450 by the information-writing unit 440 are sent to the ink-character printing device 100 via the communication units 420, 140. Based on the input print data and the process-specifying code C1 corresponding to the input coded specification number, the printing unit 120 of the ink-character printing device 100 executes a printing operation on the tape T.

On the other hand, when the embossing operation is to be performed, the braille-embossing device 200 reads the process-specifying code C1 printed on the tape T by using the reading unit 210. Based on the specification number obtained by decoding the read result, the information-readout unit 220 reads out the corresponding emboss data from the memory unit 450 via the communication units 240, 420. Based on the read emboss data, the embossing unit 230 performs a braille-embossing operation.

According to the fourth embodiment, the PC 400 functions as the input unit 410, the display unit 430, and the information-writing unit 440 so that the operationality for the input and the editing of the information is improved and that the structure of the ink-character printing device 100 is simplified.

The communication units 140, 420 only need to be communicable with each other at least when the PC 400 sends the print data and the specification number to the ink-character printing device 100. Similarly, the communication units 240, 420 only need to be communicable with each other at least when the braille-embossing device 200 reads out the emboss data. Furthermore, the ink-character printing device 100, the braille-embossing device 200, and the PC 400 may be connected via a network, such as the Internet.

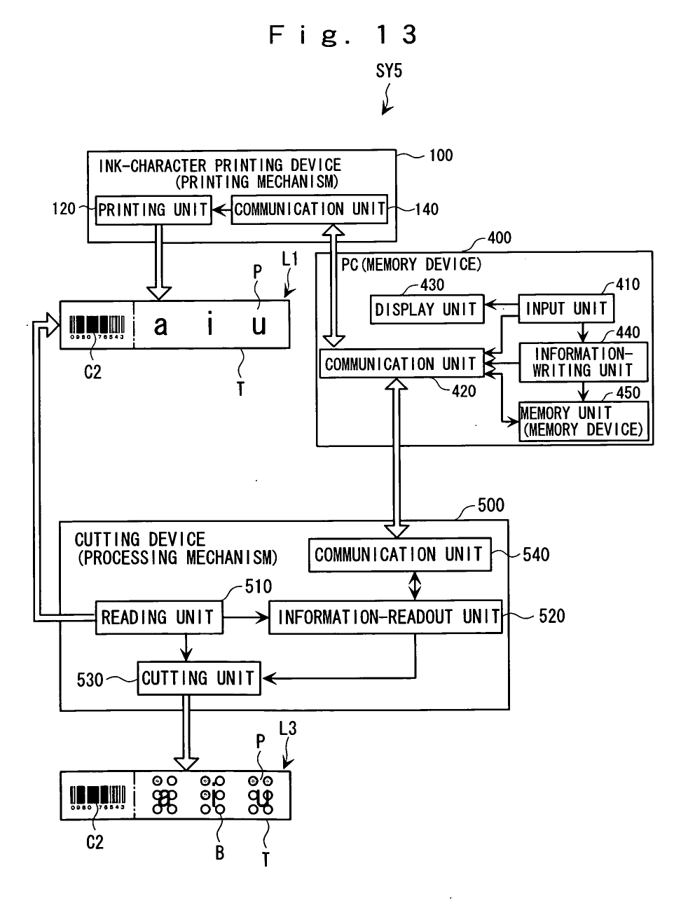

A fifth embodiment of the invention will now be described with reference to FIGS. 13, 14, 15A, 15B, and 15C. Although the braille-embossing operation is performed after the ink-character printing operation in the above-described embodiments, a text cutout operation is performed in the fifth embodiment in place of the braille-embossing operation. Thus, a label-making system SY5 according to the fifth embodiment mainly includes the ink-character printing device 100, a cutting device 500 for performing the text cutout operation, and the PC 400. The label-making system SY5 according to the fifth embodiment will be described below by focusing on the differences from the fourth embodiment.

FIG. 13 is a functional block diagram of the label-making system SY5 according to the fifth embodiment. As shown in FIG. 13, the label-making system SY5 according to the fifth embodiment mainly includes the ink-character printing device 100, the cutting device 500, and the PC 400. Specifically, the ink-character printing device 100 includes the printing unit 120 and the communication unit 140. The cutting device 500 includes a reading unit 510, an information-readout unit 520, a cutting unit 530, and a communication unit 540. The PC 400 includes the input unit 410, the communication unit 420, the display unit 430, the information-writing unit 440, and the memory unit 450.

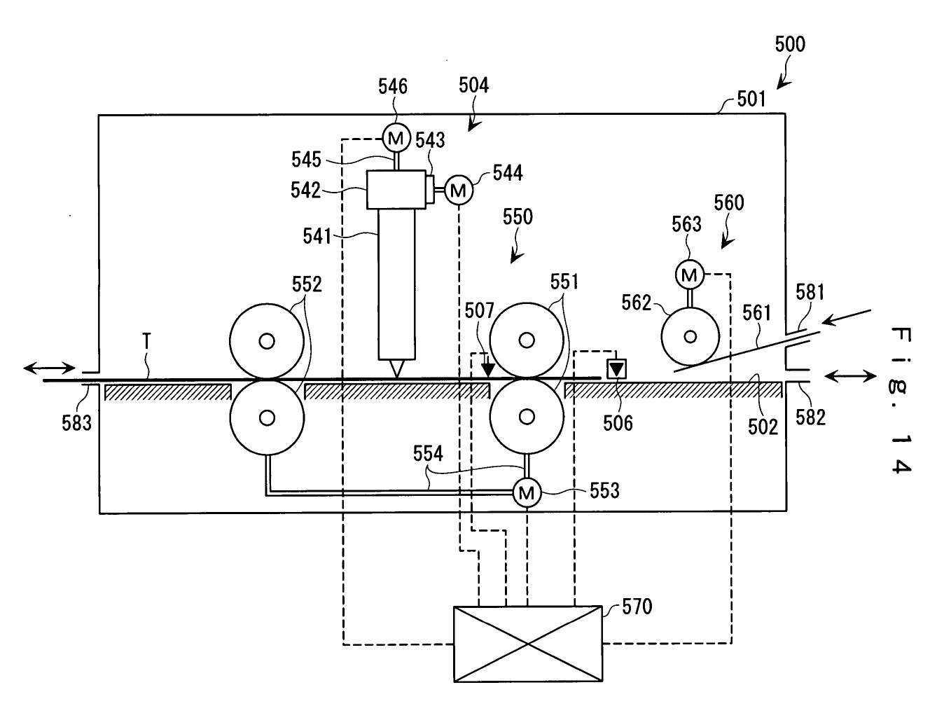

The reading unit 510 of the cutting device 500 includes a code-reading sensor 506 (see FIG. 14) and a decoder (not shown). The information-readout unit 520 reads out cutting data via the communication units 540, 420 based on a specification number, which is the read result of the reading unit 510 (i.e. the decoded result of a cutting-specifying code C2). Based on the read cutting data, the cutting unit 530 forms cutout text CT on the tape T. The cutout text CT is formed by half-cutting along the outline around a cutout-text region (i.e. by cutting only the base sheet Ta of the laminated base sheet Ta and release sheet Tb as shown in FIG. 3). The tape T having the cutout text CT forms a cutout label LB3, which is the end product.

When performing the printing operation, the input unit 410 of the PC 400 first receives the printing information to be used by the printing unit 120 for printing the ink characters P on the tape T and the cutting information to be used by the cutting device 500 for performing the text cutout operation. For example, when producing a cutout label LB3 by printing a string of Japanese kana ink characters “a-i-u” and cutting around a region surrounding the three ink characters P (to form the cutout text CT), character information for “a-i-u” is input as the printing information and a “circular outline” setting is selected as the cutting information.

Based on the printing information and the cutting information input to the input unit 410, the display unit 430 implements a preview display of the braille label LB2 on the display screen D (see FIG. 12). Furthermore, the information-writing unit 440 writes the cutting data, which is a control program and/or control data generated based on the cutting information, into the memory unit 450 in correspondence with a specification number for specifying the cutting data. Here, the cutting data includes the shape, the number, and the position of the cutout text CT.

The PC 400 sends the print data generated based on the printing information input in the input unit 410 and the specification number for specifying the corresponding cutting data to the ink-character printing device 100 via the communication units 420, 140. The printing unit 120 of the ink-character printing device 100 prints the received print data and the cutting-specifying code C2 corresponding to the specification number on the tape T. Furthermore, similar to the first embodiment, the ink-character printing device 100 performs the half-cutting process during the printing operation of the printing unit 120 in order to divide the tape T into the non-printing region and the printing region (see FIG. 4). After the printing operation, the full-cutting process is performed, thereby producing the ink-character label LB1.

In the text cutout operation, the cutting device 500 reads the cutting-specifying code C2 using the reading unit 510. Based on the specification number corresponding to the decoded result of the cutting-specifying code C2, the information-readout unit 520 reads out the corresponding cutting data from the memory unit 450 via the communication units 540, 420. Based on the read cutting data, the cutting unit 530 cuts along the outline for the cutout text CT, thereby producing the cutout label LB3.

Referring to FIG. 14, the structure of the cutting device 500 will be described below. As shown in FIG. 14, the cutting device 500 includes a housing 501 defining the frame of the cutting device 500, a cutting mechanism 504 (the cutting unit 530) that performs outline-cutting, a cutting-conveying mechanism 550 that conveys the tape T in the forward and reverse directions along a tape-traveling path 502 extending horizontally inside the housing 501, and a feeding mechanism 560 that guides the manually-inserted tape T to the tape-traveling path 502. Moreover, the cutting device 500 further includes the code-reading sensor 506 (reading unit 510) which is disposed between the cutting-conveying mechanism 550 and the feeding mechanism 560 and faces the tape-traveling path 502, a leading-end detector 507 disposed downstream of main conveying rollers 551, and a controller 570 (control unit) that entirely controls the mechanisms.

A first end of the housing 501 is provided with an insertion slot 581 through which the tape T is manually inserted. The feeding mechanism 560 faces the insertion slot 581 from the inside of the housing 501. The first end of the housing 501 is also provided with a first ejection slot 582 which is disposed directly below the insertion slot 581 and adjacent to the upstream end of the tape-traveling path 502. A second end of the housing 501 is provided with a second ejection slot 583 disposed adjacent to the downstream end of the tape-traveling path 502. The tape T inserted into the insertion slot 581 is guided to the tape-traveling path 502 by the feeding mechanism 560. Subsequently, the tape T is subject to a forward-backward conveying operation by the cutting-conveying mechanism 550 and the cutting operation by the cutting mechanism 504 along the tape-traveling path 502, such that the cutout text CT having a predetermined shape is formed on the tape T by outline-cutting. During the forward-backward conveying operation of the cutting mechanism 504, the tape T is temporarily ejected from the housing 501 through the first ejection slot 582.

The feeding mechanism 560 includes a guiding plate 561 extending downward at an angle from the insertion slot 581 towards the tape-traveling path 502, a feeding roller 562 disposed on the guiding plate 561, and a feeding motor 563 for driving the feeding roller 562. After the tape T is inserted (manually) through the insertion slot 581 along the guiding plate 561, the user may perform a predetermined starting operation. Subsequently, the feeding motor 563 rotates the feeding roller 562 so that the tape T is conveyed to the tape-traveling path 502. When the leading end of the tape T reaches the code-reading sensor 506, the code-reading sensor 506 reads the cutting-specifying code C2 printed on the tape T, and the cutting-conveying mechanism 550 simultaneously starts to operate. Thus, the tape T is transferred from the feeding mechanism 560 to the cutting-conveying mechanism 550.

The cutting-conveying mechanism 550 includes the main conveying rollers 551 disposed upstream of the cutting mechanism 504, sub conveying rollers 552 disposed downstream of the cutting mechanism 504, a conveying motor 553 that rotates the rollers 551, 552 in the forward and reverse directions, and a power transmission mechanism 554 that transmits the rotational force of the conveying motor 553 to the rollers 551, 552. The main conveying rollers 551 control the conveying distance of the tape T with respect to the forward and reverse directions. The sub conveying rollers 552 are subject to slip rotation (the conveying distance is at maximum in the forward conveying operation and is at minimum in the reverse conveying operation) so as to give tension to the tape T being conveyed. The leading end of the tape T transferred from the feeding mechanism 560 to the main conveying rollers 551 is detected by the leading-end detector 507, which is positioned downstream of the main conveying rollers 551. Based on this detection, the conveying distance of the tape T is accurately controlled. In synchronization with the cutting-conveying mechanism 550, the cutting mechanism 504 performs the cutting operation in a reciprocating manner.

The cutting mechanism 504 includes a cutting tool 541 whose tip is provided with an angular blade rotatable around a vertical axis, a tool carriage 542 for supporting the cutting tool 541, a timing belt 543 for reciprocating the cutting tool 541 via the tool carriage 542 in a direction perpendicular to the tape-traveling path 502, and a carriage motor 544 for driving the timing belt 543 in the forward and reverse directions. Moreover, the cutting mechanism 504 further includes a vertical-reciprocation mechanism 545 that moves the cutting tool 541 upward and downward via these components, and a vertical-reciprocation motor 546 that drives the vertical-reciprocation mechanism 545.

The carriage motor 544 drives the timing belt 543 in the forward and reverse directions so as to reciprocate the cutting tool 541 via the tool carriage 542 fixed to the timing belt 543. Thus, the cutting tool 541 performs the cutting operation in a reciprocating manner. Moreover, since the cutting-conveying mechanism 550 conveys the tape T in the forward and reverse directions in synchronization with the cutting operation of the cutting tool 541, the outline-cutting for the cutout text CT is achieved. Furthermore, the vertical-reciprocation motor 546 is driven at the start and the end of the outline-cutting process so that the cutting tool 541 is shifted in the vertical direction.

Accordingly, the outline-cutting process is achieved by the forward and reverse conveying operation of the tape T by the cutting-conveying mechanism 550 and the reciprocating movement of the cutting tool 541 by the cutting mechanism 504, whereby the cutout text CT having a predetermined shape is formed. In the fifth embodiment, the information related with the shape and the position of the cutout text CT is read out from the PC 400 (the memory unit 450) based on the read result of the cutting-specifying code C2 printed on the tape T. The cutting operation is performed based on the read cutting data.

According to the fifth embodiment, even though the operation for forming the cutout text CT is set to be performed after the printing operation, the operations based on the preliminarily input and edited printing information and cutting information are performed independently in the ink-character printing device 100 and the cutting device 500 in order to produce the cutout label LB3.

Although the half-cutting process for dividing the tape T into the non-printing region and the printing region is performed in the ink-character printing device 100 according to the fifth embodiment, the half-cutting process may alternatively be performed using the cutting mechanism 504 (the cutting unit 530) of the cutting device 500.

Furthermore, although the ink-character printing device 100 and the cutting device 500 are separate devices in the fifth embodiment, the two devices 100 and 500 may alternatively be included in a single apparatus as in the first embodiment. Furthermore, the input unit 410 and the display unit 430 may alternatively be included in the ink-character printing device 100, and moreover, the memory unit 450 may alternatively be included in the ink-character printing device 100 or the cutting device 500.

Furthermore, although the inserted tape T is transferred through the feeding roller 562, the code-reading sensor 506, the main conveying rollers 551, and the leading-end detector 507 in that order according to the fifth embodiment, the code-reading sensor 506 may alternatively be disposed adjacent to the downstream side of the leading-end detector 507, as in FIG. 4. Furthermore, the tape-traveling path 70 of the braille-embossing portion 20 described in the first embodiment may alternatively be provided with the feeding roller 562, such that the code-reading operation and the conveying operation are performed based on the order described in the fifth embodiment.

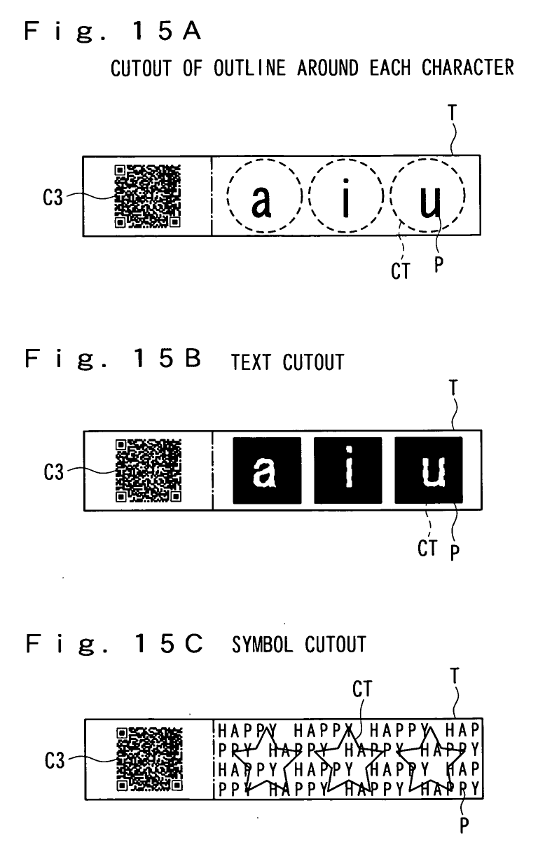

Alternatively, the cutting device 500 is capable of forming other various types of cutout text CT. For example, as shown in FIG. 15A, the cutting information input to the input unit 410 may indicate a setting for providing a cutout outline around each character, such that each outline defines the cutout text CT. The cutout text CT of this type may be achieved by, for example, inputting information under the setting for “outline types for cutout text” included as one of decoration settings for the characters.

Furthermore, referring to FIG. 15B, the input printing information may include a specification for printing black squares as the ink characters P such that the number of the black squares is in correspondence with that of the characters. Moreover, the input cutting information may include a specification for cutting out each character aligned with the corresponding black square. In this case, the cutout text CT of this type may be achieved by, for example, selecting “text cutout” included as one of decoration settings for the characters. In this case, in order to perform only the cutting operation of the characters without printing out the ink characters P, for example, the setting “character clipping” may be selected. In this setting, the ink-character printing device 100 only prints out the cutting-specifying code C2 and produces a blank label with a predetermined length. Subsequently, the cutout text CT may be formed in the cutting device 500.

Furthermore, referring to FIG. 15C, the input printing information may include a specification for printing a text pattern as the ink characters P. Moreover, the input cutting information may include a specification for forming cutout text CT of a predetermined symbol over the text pattern. This can be achieved by, for example, inputting information under the setting for “pattern printing” for the printing mode, and then switching to the cutting mode to select the setting for “text (symbol) cutout”.

In the first to fifth embodiments described above, the specification number for specifying the emboss data or the cutting data is printed on the tape T as a process-specifying code (bar code) C1 or C2. As an alternative to a code, a code string or a mark including a plurality of symbols or characters (text), such as the specification number (numeral value) itself, may be printed. Furthermore, for the braille-embossing operation, the text data (corresponding to the string of kana characters “a-i-u”, for example) indicating the braille translation may be printed. For the text cutout operation, the numerical values indicating the shape and the size of the cutout text CT may be printed. In other words, any type of information is permitted as long as the content included in the information is readable by the device performing the operation.

Furthermore, each portion (each function) included in the label-making systems SY3, SY4, SY5, the label-making apparatus 1, the ink-character printing device 100, the braille-embossing device 200, the PC 400, or the cutting device 500 may be provided as a program. Moreover, such a program may be provided by storing the program in a storage medium (not shown). The storage medium may be, for example, a CD-ROM, a Flash ROM, a memory card (e.g. CompactFlash (registered trademark), SmartMedia, Memory Stick), a compact disc, a magneto-optical disc, a digital versatile disc, or a flexible disc.

Furthermore, the configuration of the label-making system SY, the configuration of each of the devices, the type of information-formation medium, and each of the operations are not limited to the above embodiments, and modifications are permissible within the scope and spirit of the invention. Furthermore, in cases other than performing the braille-embossing operation or the text cutout operation, such as performing a printing operation using multiple colors, a first printing device and a second printing device may be used so that the content of the printing operation to be performed in the second printing device may be printed as a process-specifying code in the first printing device. In other words, the embodiments of the invention are applicable to systems or devices that perform a printing operation on an information-formation medium and subsequently perform any kind of operation on the same information-formation medium.

An operation to be performed after the printing operation is not limited to one type. For example, various types of operations may be performed after the printing operation. In that case, a plurality of specification numbers for performing a plurality of operations may be included in a single process-specifying code, or a plurality of specification numbers may be provided in correspondence with the plurality of operations.

It is further understood by those skilled in the art that the foregoing is the preferred embodiment of the present invention, and that various changes and modifications may be made without departing from the spirit and scope thereof.

What is claimed is:

1. A printing/processing system comprising:
a printing mechanism performing a printing operation on a processing sheet;
a processing mechanism performing a processing operation on the printed processing sheet; and
a memory device into which the printing mechanism writes information and from which the processing mechanism reads information,
wherein the printing mechanism includes:
an input unit for inputting printing information for performing the printing operation and processing information for allowing the processing mechanism to execute the processing operation;
an information-writing unit that writes process data into the memory device in correspondence with process-specifying data provided for specifying the process data, the process data being a control program and/or control data based on the input processing information; and
a printing unit that prints print data and the process-specifying data on the processing sheet, the print data corresponding to the input printing information,
wherein the processing mechanism includes:
a reading unit that reads the process-specifying data printed on the processing sheet;
an information-readout unit that refers to the memory device and reads out the process data corresponding to the read process-specifying data from the memory device; and
a processing unit that performs the processing operation based on the read process data.

2. The printing/processing system according to claim 1, wherein the process-specifying data is an optically readable code.

3. The printing/processing system according to claim 1, wherein the processing sheet includes an information formation layer on which the printing operation is performed, and a release layer attached to a rear surface of the information formation layer,
wherein the printing mechanism further includes a half-cutting unit that half-cuts the processing sheet in a width direction thereof in a manner such that the information formation layer is cut along a position proximate a leading end or a trailing end of the processing sheet with respect to a conveying direction of the processing sheet, the information formation layer thus being given a non-printing region in which the print data is not printed, and
wherein the printing unit prints the process-specifying data in the non-printing region.

4. The printing/processing system according to claim 1, wherein the processing operation performed on the processing sheet by the processing unit includes a braille-embossing operation and/or a text cutout operation.

5. The printing/processing system according to claim 1, wherein the memory device is included in a personal computer, and
wherein the printing mechanism and the processing mechanism are independent of each other, and each includes a communication unit that communicates with the personal computer.

6. The printing/processing system according to claim 5, wherein the personal computer also functions as the input unit and the information-writing unit.

7. A printing device functioning as the printing mechanism included in the printing/processing system according to claim 1.

8. The printing device according to claim 7, wherein the memory device is included in the printing device, and
wherein the printing device includes a communication unit that communicates with the processing mechanism.

9. A processing device functioning as the processing mechanism included in the printing/processing system according to claim 1.

10. The processing device according to claim 9, wherein the memory device is included in the processing device, and
wherein the processing device includes a communication unit that communicates with the printing mechanism.

11. A printing/processing apparatus having a single housing in which the printing mechanism, the processing mechanism, and the memory device included in the printing/processing system according to claim 1 are disposed.

12. A method for controlling a printing/processing system that performs a printing operation on a processing sheet and a processing operation on the processing sheet, the method comprising:
obtaining printing information for performing the printing operation and processing information for performing the processing operation;
writing process data into a memory device in correspondence with process-specifying data provided for specifying the process data, the process data being a control program and/or control data based on the obtained processing information;
printing print data and the process-specifying data on the processing sheet, the print data corresponding to the obtained printing information;
reading the process-specifying data printed on the processing sheet;
reading out the process data corresponding to the read process-specifying data by referring to the memory device; and
performing the processing operation based on the read process data.

13. A program for allowing a computer to implement the steps included in the method for controlling the printing/processing system according to claim 12.

14. A computer-readable storage medium storing the program according to claim 13.
